(19) United States
(12) Patent Application Publication
(10) Pub. No.: US 2024/0254974 A1
(43) Pub. Date: Aug. 1, 2024

(54) STRAIN MULTIPLYING COMPRESSION ENGINE

(71) Applicant: Recovery Force, LLC, Fishers, IN (US)

(72) Inventors: Ryan Hamilton, Livingston, MT (US); Jeffrey Schwegman, Indianapolis, IN (US)

(21) Appl. No.: 18/418,568

(22) Filed: Jan. 22, 2024

Related U.S. Application Data
(60) Provisional application No. 63/481,811, filed on Jan. 27, 2023.

(51) Int. Cl. F03G 7/06

(52) U.S. Cl. CPC F03G 7/062; F03G 7/06143; F03G 7/064; F05B 2280/5006

(57) ABSTRACT

A compression apparatus includes a pair of compression engines incorporating shape memory alloy (SMA) wires configured to provide compression to the limb or torso of a person. The compression engines are in an overlapping arrangement to provide a strain capability of the compression apparatus that is greater than the additive strain capability of the pair of compression engines.

### REFERENCE TO RELATED APPLICATION AND PRIORITY CLAIM

This application is a utility filing from and claims priority to provisional application No. 63/481,811, filed on Jan. 27, 2023, the entire disclosure of which is incorporated by reference herein.

### BACKGROUND

The present disclosure relates to compression devices for applying compression to a part of a person's body, such as for alleviating muscle soreness, restricting movement, or preventing deep vein thrombosis. Applicant's issued U.S. Pat. Nos. 9,326,911; 10,441,491; 10,426,202; 10,791,772 and 10,918,561 disclose devices for applying compression to parts of the body. These devices rely on wires that change length when current is applied to the wire—i.e., shape memory metal (SMA) wires. SMA wires have an inherent physical limit to the amount of change in length that the wire can achieve, or more specifically to the strain (change in length divided by original length) capability. Some SMA wires can achieve an 8% strain at full activation power. The compression applied depends on the overall length of the SMA wires of the compression engine and the strain capability of those wires. For example, 12-in. wire encircling a user's arm will reduce length by 0.72 in. for a 6% strain capability, whereas a 6-in. wire incorporated into a wrap encircling the user's arm will only have a length reduction of 0.36 in. which might be insufficient compression. For certain compression protocols, the amount of compression required can exceed the strain capabilities of the SMA wire, or the engine that incorporates the SMA wire. Some complex wire configurations can be provided that, in effect, increase the length-change effect for the fixed change-in-length capabilities of a particular type of SMA wire. However, these configurations typically require longer wires and larger engines to accomplish the desired overall change in length and thus the desired amount of compression.

There is a need for a compression engine assembly that can achieve greater changes in length, and thus, greater compression than prior devices.

### DESCRIPTION OF THE DRAWINGS

FIG. 1 is a top view of a compression engine according to the present disclosure, with the engine shown in its un-activated state.

FIG. 2 is a top view of the compression engine shown in FIG. 1, with the engine shown in its activated state.

FIG. 3 is a side view of the compression engine shown in FIG. 1.

FIG. 4A is an enlarged view of region 4A in FIG. 3.

FIG. 4B is an enlarged view of region 4B in FIG. 3.

FIG. 5 is a perspective view of a compression apparatus, configured to be worn on the leg of a user and which incorporates the compression engine of FIGS. 1-4B.

FIG. 6 is a graph of system strain in relation to the overlap distance of the compression engines of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

The compression engine 10 disclosed herein uses one or more wires formed from a phase-change material that changes length when driven by a current. In one example, the material is a shape-memory alloy (SMA), such as Nitinol or Flexinol®. The SMA wires are integrated into a compression device, such as a strap or wrap that is configured to encircle the limb or torso of a person. Details of such compression devices are found in Applicant's issued U.S. Pat. Nos. 9,326,911; 10,441,491; 10,426,202; 10,791,772; and 10,918,561, the disclosures of which are incorporated herein by reference. The SMA wires are connected to the ends of the strap, and particularly to a substrate or circuit board that connects the SMA wires to an electrical power supply, preferably through a controller that controls the current applied to the wires.

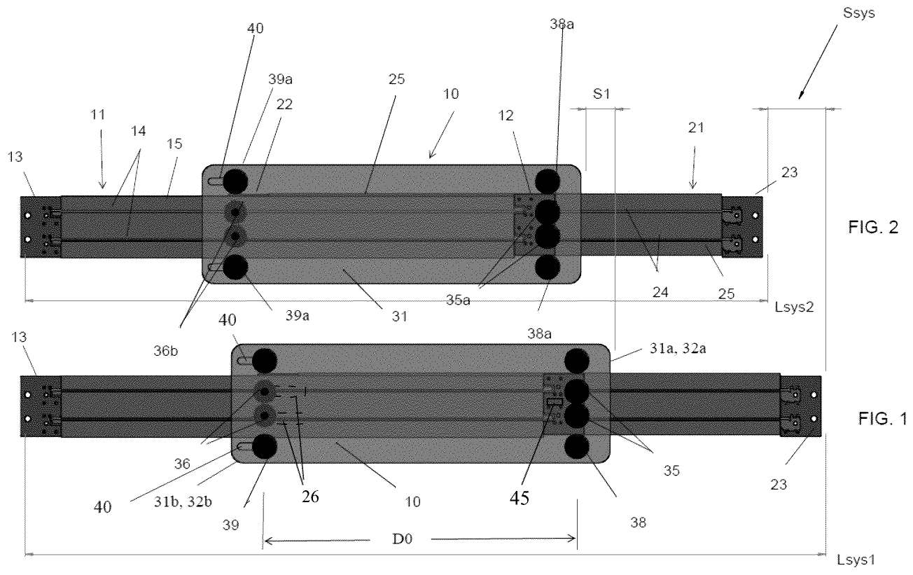

As shown in FIGS. 1-4, the compression engine 10 includes two engines 11 and 21 that overlap each other in a manner that results in additive strain or length reduction of the compression engine, and ultimately a length reduction of the strap to be tightened on the user. The first engine 11 includes one or more SMA wires 14 fastened to end substrates 12, 13 at opposite ends of a flexible panel 15. Similarly, the second engine 21 includes one or more SMA wires 24 fastened to end substrates 22, 23 at opposite ends of a flexible panel 25. It can be appreciated that one of the end substrates for each engine, such as substrates 12/22 or substrates 13/23, can include control circuitry 45 that is configured to interface with an electrical power supply and control module configured to control the compression engine. Suitable interfaces can be as disclosed in U.S. Pat. No. 10,441,491, incorporated above, namely the interface (703, 716), together with a suitable control module, such as the control module (715) for the compression assembly (702) shown in FIGS. 31-33, which drawings and associated description are specifically incorporated herein by reference. The control circuitry 45 of the compression engine 10 can include electrical wires, such as the wires (703) that can be connected to wires (716) of the interface that are connected directly to the control module (715). The control module can include a microcontroller for controlling the activation of the SMA wires according to a pre-determined compression protocol, such as the micro-controller (24) described at col. 7, ln. 18-col. 9, ln. 3 of the '491 patent, which description is incorporated herein by reference.

One end of each of the SMA wires 14, 24 is connected to a corresponding one of the substrates 12, 22. The opposite end substrates, namely substrates 13 and 23, anchor the opposite end of the respective SMA wires 14, 24. Moreover, the opposite end substrates 13, 23 are attached to the strap or panel that encircles the person's limb or body. For example, a compression apparatus or garment 50 can in the form of a flexible panel 51 that configured to encircle the leg of a person. A series of closures 52 can be provided to adjustably pre-tension the panel 51 on the leg. A series of compression engines 10 can be attached to the panel 51 between the mating ends of each closure 52. Alternatively, the end substrates 13, 23 can be connected or connectable to each other, in which case the flexible panels 15, 25 would need to be long enough so that their combined length allows the compression engine to encircle the person's limb or body.

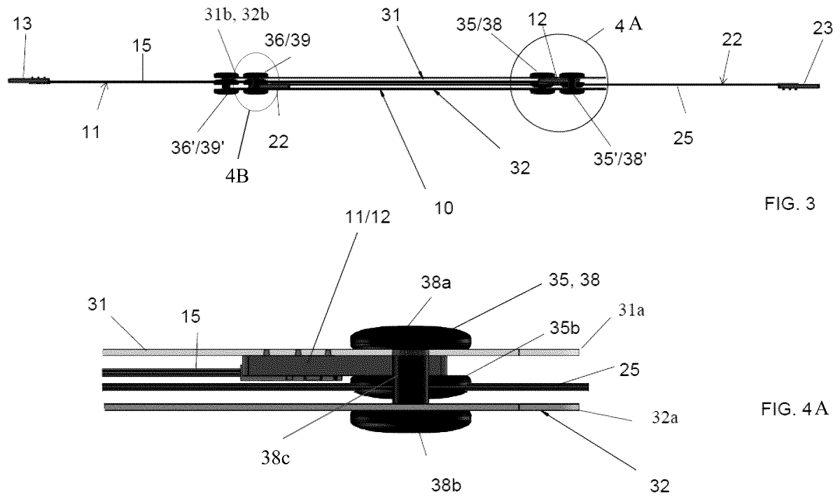

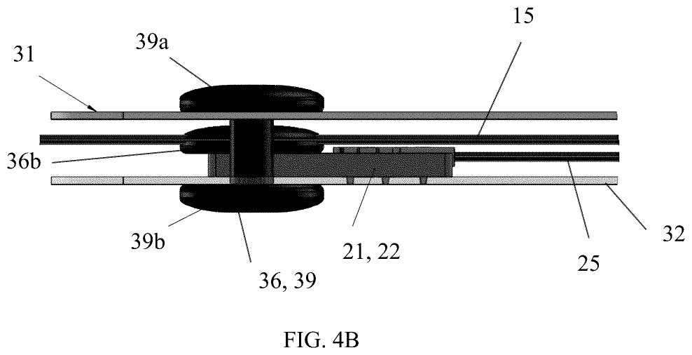

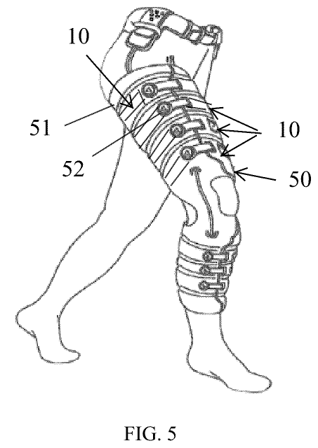

In one embodiment, the end substrates 12, 22 can be designated as the control substrate 12, 22 for the associated engine 11, 21. The control substrates 12, 22 are not connected directly to each other in a serial or end-to-end manner. Instead, the engines 11, 21 overlap each other, with each control substrate 12, 22 fastened to a respective one of a pair of relatively rigid plates 31, 32, as best seen in FIGS. 3-4. The end substrates 13 and 23 form the free ends of the compression engine 10 that can be engaged to each other to encircle the body portion of the user, or that can be integrated into a compression device such as the device 50 shown in FIG. 5.

The two rigid plates 31, 32, to which a respective one of the control substrates 12, 22 is connected, can be substantially rigid to remain flat in use, depending on the particular use of the compression engine 10, such as to apply compression to a person's torso. However, for many applications, a certain amount of curvature is required for the compression engine to fit comfortably on the person's limb or body. In this case, the plates 31, 32 are more rigid than the flexible panels 15, 25 while still retaining enough flexibility to bend as needed to conform to the patient's body. In this case, the plates 31, 32 can be formed of a nylon or HDPE material. Alternatively, the plates 31, 32 can be formed with a curvature calibrated to conform to the limb or body portion about which the compression device is worn. The two plates 31, 32 have a length less than the overall length of the compression engine 10, a preferably about half of the overall length.

The two engines are sandwiched between the two plates 31, 32. The first engine 11 is fastened to the upper plate 31. In particular, the control substrate 12 is fastened to one end of the top plate 31 by a rivet 35 or other suitable fastener. In the illustrated embodiment, one head 35a of the rivet 35 engages the plate 31, as shown in FIG. 2, while the opposite head 35b engages the underside of the control substrate 12, as shown in FIG. 4A, to fix the control substrate to the top plate 31. A similar construction is applied at the opposite end 32b of the bottom plate 32, with rivets 36 fastening the second engine 22 to the bottom plate 32, as shown in FIG. 4B. It can be appreciated that the heads 36b of the rivets 36 shown in FIG. 2 are beneath the top plate 31. The heads of the rivets 35, 36 need not be affixed to the surface of the respective plate or substrate. Instead, the rivets can be compression rivets in which two halves are compressed together to clamp the plate and substrate together.

The control substrates 12, 22 of the two engines 11, 21 are fastened to respective top and bottom plates 31, 32, with the remaining length of the two engines 11, 21 passing in opposite directions between the two plates, as seen in FIGS. 1-2. The top and bottom plates 31, 32 are fastened to each other so that the plates are offset by a width sufficient for passage of the flexible panels 15, 25 between the two plates. In one embodiment, the plates are connected by fasteners, such as rivets 38 at the opposite ends 31a, 32a of the plates, with one head 38a of the rivets engaging or fixed to the top plate and the opposite head 38b engaging or fixed to the bottom plate, as shown in FIG. 4. A post 38c connecting the two heads 38a, 38b defines the spacing between the two plates. As seen in FIGS. 1-2, the two rivets 38 straddle the flexible panels 15, 25 of the two engines 11, 21, in particular so that the flexible panel 25 can freely slide longitudinally between the posts 38c of the two rivets. The heads of the rivets 38 can be fixed or adhered to the respective plate, or the posts of the rivets can include a step to engage the surface of the plate opposite the rivet head, with a compression fit clamping the plate between the step and the rivet head.

The opposite ends 31b, 32b of the plates are also connected by rivets 39, as shown in FIG. 2, with the rivets straddling the flexible panels 15, 25, in particular so that the flexible panel 15 can freely slide longitudinally between the posts of the two rivets 39. The rivet head 39b can be fixed to the bottom plates in the manner described above for the rivets 38. But, unlike the rivets 38, the rivet head 39a of each rivet 39 is not fixed to the top plate 31, like the rivet head 38a. Instead, the end 31b of the top plate 31 defines a pair of slots 40 on opposite sides of the width of the plate, through which each rivet 39 extends. The rivet head 39a is thus capable of sliding relative to the top plate 31. The slot allows the two plates 31, 32 to bend when the compression engine 10 is engaged on the body of a person, and particularly when the compression engine and associated strap are wrapped around a limb of the person. In this case, the top plate 31 will bend around a greater circumference than the bottom plate 32. The slot allows the rivet to travel as needed to accommodate the differential bending circumference of the two plates. A similar slot can be provided at the opposite end 31a of the top plate 32, but is not required.

It is contemplated that an additional set of rivets 38′, 39′ can be provided to couple the top and bottom plates 31, 32 in addition to the rivets 38, 39 described above. Similarly, an additional set of rivets 35′, 36′ can be provided to couple the flexible panels 15, 25 to a respective top and bottom plate 31, 32, in addition to the rivets 35, 36 discussed above.

A comparison of FIGS. 1 and 2 shows the functionality of the compression engine 10 of the present disclosure. The engine is shown in its un-activated, or resting, state in which no current has been applied to the SMA wires 14, 24 of the compression engine. In that state, the two overlapping engines 11, 21 have a combined length of L_{sys}1. The amount of overlap between the two engines corresponds to the distance D₀ between the rivets 35, 36 that fasten the engines to the respective top and bottom plate. When each engine 11, 21 is activated, the length of the respective SMA wires 14, 24 is reduced by a distance S1. When both engines 11, 21 are activated, the combined reduction in length of the SMA wires 14, 24 is the dimension S_{sys} in FIG. 2, which can be considered to be the stroke of the compression engine 10. It can be appreciated that the stroke S_{sys} is the sum of the strokes of each engine 11, 21, namely the distance S1. However, it can be appreciated that the stroke of each engine does not need to be the same. In any case, the stroke of the entire compression engine 10 will still equal the sum of strokes of the two engines. It can be appreciated that the overlapping arrangement of the two engines 11, 21 reduces the footprint of the compression engine 10 relative to a single engine having a comparable system stroke. A device having an equivalent stroke would need to be much longer than the compression engine 10—either the SMA wire lengths would need to be much longer to achieve the same stroke, or two engines would have to be engaged in series.

The design of the compression engine 10 can be reduced to a series of equations relating the lengths and strokes of the components of the engine 10. The length referred to below is the active length of the SMA wires in the engines, since it is this length that undergoes strain when activated.

$$\begin{matrix}{L}_{e 1} = Length of engine 11 \\ {L}_{e 2} = Length of engine 21 \\ {L}_{sys} = Length of system when overlapped \\ {D}_{o} = distance the engines are overlapped \\ {L}_{eq} = Equivalent length of engines 11 , 21 if they were aligned in series \\ {L}_{eq} = {L}_{e 1} + {L}_{e 2} \\ {L}_{sys} = {L}_{e 1} + {L}_{e 2} - {D}_{o} , or {L}_{sys} = {L}_{eq} - {D}_{o} \\ e = Strain of SMA wire , \% \\ {e}_{sys} = Strain of system , \% \\ S = Stroke in units of length , inch , mm , etc . \\ {S}_{sys} = Stroke of system \\ {S}_{eq} = Stroke of an equivalent length system \\ S = {S}_{sys} = {S}_{eq} \\ e = ( S / {L}_{eq} ) * 100 \\ S = {L}_{eq} * e / 100 \\ {e}_{sys} = ( S / {L}_{sys} ) * 100 \\ S = {L}_{sys} * {e}_{sys} / 100 \\ Δ e = 100 * ( {e}_{sys} - e ) / e = Cha nge in strain ( \% ) .\end{matrix}$$

In an example, two engines 11, 21 of equal length at 8 in. are overlapped by 4 in. Tin one example, the SMA wires of the engines each have a strain of 5% when activated corresponding to the reduction in length, S1. Applying the above equations:

$$\begin{matrix}{L}_{e 1} = {L}_{e 2} = 8 in . \\ {D}_{o} = 4 in . \\ e = 5 \% \\ {L}_{eq} = {L}_{e 1} + {L}_{e 2} , {L}_{eq} = 8 in . + 8 in . = 16 in . \\ {L}_{eq} = 16 in . \\ S = {L}_{eq} * e / 100 = 16 in . * 5 \% / 100 = 0.8 in . \\ S = 0.8 in . \\ {L}_{sys} = {L}_{eq} - {D}_{o} = 16 in . - 4 in . = 12 in . \\ {L}_{sys} = 12 in . \\ {e}_{sys} = ( S / {L}_{sys} ) * 100 = ( 0.8 / 12 ) * 100 = 6.67 \% \\ {e}_{sys} = 6.67 \%\end{matrix}$$

Thus, the change in strain is: Δe=100*(e_{sys}−e)/e=100*(6.67−5)/5=33.4%

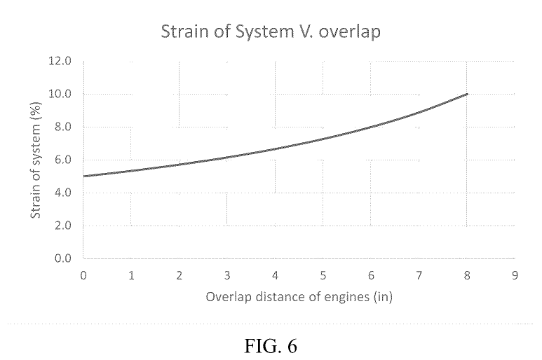

With the overlap configuration described above, the e_{sys}=6.67%, is an increase in strain of 33.4% over a standard 16 in. engine length footprint. It can be appreciated that the larger the overlap distance (Dₒ) the larger the increase in the strain of the system (e_{sys}) will be as represented in the graph of FIG. 6.

Using the above equations, the strain for a given compression engine 10 can be fine-tuned by calibrating the overlap distance based on the needs of the situation/required therapy. For example, if a lower pressure therapy treatment is needed for a lymphedema patient, the overlap can be minimized so the strain is minimized, leading to a reduction in the pressure applied to the body. If a high-pressure therapy is required, the overlap can be maximized to increase the system strain and maximize the pressure applied to the body.

For example, if a strain of 5.5% is required for the system to reach the desired pressure for therapy and the engines are 8 in. in length the required overlap Do can be calculated as follows.

$$\begin{matrix}e = 5 \% ( the strain capability of each SMA wire ) \\ {L}_{eq} = {L}_{e 1} = {L}_{e 2} = 8 in . \\ S = {L}_{eq} * e / 100 = 16 in . * 5 \% / 100 = 0.8 in .\end{matrix}$$

Then Dₒ=2*L_{eq}−(S/e_{sys})*100, Dₒ=2*8−(0.8/5.5)*100=1.45 in. In other words, the two 8 in. length engines need to be overlapped by 1.45 in. to achieve the desired pressure on the person.

This can also be advantageous on smaller diameter limbs. If there is a DVT need where the limb size is small, and the pressure needs to be significant, the overlap can be adjusted to match the limb size so no strain is lost to overlap and the force delivered by the system is maximized.

These distances of overlap can be adjustable for flexibility of use or fixed in a device for a specific use. The ability to overlap the engine allows for flexibility of the application of certain SMA materials, such as Nitinol (NiTi). Since NiTi has a given strain based on length, its use can be limited. By overlapping the engines, the strain of the system is increased, resulting in a larger strain than NiTi of the length of the system alone would deliver.

In one embodiment, the compression engine 10 can be configured to allow adjustment of the overlap dimension D₀. This overlap is essentially based on the length of the top and bottom plates 31, 32. Thus, a shorter pair of plates will reduce the overlap, while a longer pair of plates will increase the overlap. In one embodiment, the overlap dimension D₀ is about half the system length L_{sys} before the SMA wires are actuated. In order to allow replacement of the plates, the rivets 35, 36, 38, 39 can be rivet screws in which one head of the rivet includes an internally threaded post and the other head includes an externally threaded stem that threads into the post. The lengths of the posts for the rivets 35, 36 are sized to fasten the control substrates 12, 22 to the respective top and bottom plate, while the lengths of the posts for the rivets 38, 39 are sized to sandwich the two engines 11, 12 between the plates 31, 32. Other fastener arrangements are contemplated that allow any given pair of engines to be fastened to any given pair of top and bottom plates, allowing fully customization of the compression engine 10 to the person. It is further contemplated that the overlap adjustment can be made by adjustable positioning of one or both sets of fasteners/rivets 35, 36 relative to the top and bottom plates. The plates can be provided with slots, such as the slot 26 shown in dashed lines in FIG. 1, which can be similar to slots 40. The slots 26 allow adjustment of the position of the rivets 36 along the length of the bottom plate 32. A similar slot arrangement can be provided in the top plate 31 for adjustment of the position of the rivets 35. The rivets can be configured to be fixed to the plate in the desired position, thereby adjusting the overlap dimension D₀ between the fasteners/rivets 35 and 36 to match the desired strain output of the compression engine 10.

The present disclosure should be considered as illustrative and not restrictive in character. It is understood that only certain embodiments have been presented and that all changes, modifications and further applications that come within the spirit of the disclosure are desired to be protected.

What is claimed is:

1. A compression apparatus comprising:
a first compression engines including;
a first elongated flexible panel having opposite ends with a substrate affixed to said panel at each of said opposite ends, wherein one of said opposite ends is a free end and the other of said opposite ends is a control end;
at least one shape memory alloy (SMA) wire extending between said opposite ends and connected to said panel at each of said opposite ends;
wherein a panel at one of said opposite ends includes control circuitry configured to interface with an electrical power supply to activate the at least one SMA wire;
a second compression engines including;
a second elongated flexible panel having opposite ends with a substrate affixed to said panel at each of said opposite ends, wherein one of said opposite ends is a free end and the other of said opposite ends is a control end;
at least one shape memory alloy (SMA) wire extending between said opposite ends and connected to said panel at each of said opposite ends;
wherein a panel at one of said opposite ends includes control circuitry configured to interface with an electrical power supply to activate the at least one SMA wire;
wherein said first and second compression engines overlap each other, with the control end of said first compression engine overlapping the second elongated panel and the control end of said second compression engine overlapping the first elongated panel, and with the free end of said first elongated panel and said free end of said second elongated panel forming opposite ends of said compression engine having an initial length therebetween when the SMA wires of the two compression engines are not actuated and a shorter length therebetween when the SMA wires of the two compression engines are actuated; and
a top plate and a bottom plate each having a length less than said initial length of said compression engine, each plate having a first and an opposite second end in which the top and bottom plates are connected to each other at said first end and at said second end, wherein said control end of said first flexible panel is connected only to said first end of said top plate and said control end of said second flexible panel is connected only to said second end of said bottom plate.

2. The compression apparatus of claim 1, further comprising a flexible panel configured to be worn on a portion of the body of a user, wherein the free end of each of the first and second compression engine is attached to said flexible panel.

3. The compression apparatus of claim 1, wherein said top and bottom plates are connected at said first end and said second end by fasteners extending between, the fasteners configured to separate the top and bottom plates by a width sufficient to receive the first and second elongated panels between the top and bottom plates.

4. The compression apparatus of claim 3, wherein two fasteners are provided at each of said first and second end of said top and bottom plates, wherein the two fasteners are separated to straddle a respective one of the first and second elongated panels passing between the top and bottom plates.

5. The compression apparatus of claim 3, wherein the fasteners are rivets.

6. The compression apparatus of claim 4, wherein:
each of said rivets includes an elongated post and an enlarged head at each end of the post; and
said first end of said top plate includes a pair of slots,
wherein the rivets at said second end of said top and bottom plates and at the first end of said bottom plate are fixed to the respective plate, and the rivets at the first end of said top plate extend through said pair of slots.

7. The compression apparatus of claim 1, wherein:
said control end of said first flexible panel is connected to said first end of said top plate by at least one first fastener engaged between the substrate and the top plate; and
said control end of said second flexible panel is connected to said second end of said bottom plate by at least one second fastener engaged between the substrate and the bottom plate.

8. The compression apparatus of claim 7, wherein the at least one fastener is a rivet.

9. The compression apparatus of claim 7, wherein:
the amount of overlap Dₒ between the first and second compression engines is the distance between the at least one first fastener and the at least one second fastener; and
wherein for an SMA wire having a strain capability of e, the amount of overlap Dₒ is calculated using the equation
$${D}_{o} = 2 * {L}_{eq} - ( S / {e}_{sys} ) * 100 ,$$
where e_{sys} is a desired amount of strain of the compression apparatus, L_{eq} is the length of SMA wires in each of the first and second compression engines and S=L_{eq}*e/100.
